(19) United States
(12) Patent Application Publication
(10) Pub. No.: US 2001/0024219 A1
(43) Pub. Date: Sep. 27, 2001

(54) Nozzle plate structure for ink-jet printing head and method of manufacturing nozzle plate

(75) Inventors: Torahiko Kanda, Tokyo (JP); Kenichi Ohno, Tokyo (JP); Yasuhiro Otsuka, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/814,419

(22) Filed: Mar. 21, 2001

(30) Foreign Application Priority Data
Mar. 21, 2000 (JP) 078864/2000

(51) Int. Cl. B41J 2/14

(52) U.S. Cl. 347/47

(57) ABSTRACT

A nozzle plate structure for an ink-jet printing head includes an annular projection formed around an opening edge of a nozzle that discharges ink. The annular projection has one or a plurality of notches in a circumference thereof. A method of manufacturing the nozzle plate is also disclosed.

### BACKGROUND OF THE INVENTION

1. Field of the Invention

The present invention relates to a nozzle plate structure used in an ink-jet printing head which prints an image and the like by flying ink droplets, and a method of manufacturing a nozzle plate.

2. Description of the Prior Art

A conventional ink-jet printing head will be described with reference to FIG. 1. FIG. 1 is a sectional view showing the schematic arrangement of a conventional ink-jet printing head. Conventionally, an ink-jet printing head of this type is comprised of a nozzle 1 formed in a nozzle plate 15 to discharge ink droplets 6, an ink pool 12, a pressure chamber 8 with a pressure generating mechanism 13, and a supply line 11 through which the ink pool 12 and pressure chamber 8 communicate with each other, as shown in FIG. 1. For example, the head is manufactured by stacking the nozzle plate 15 formed with the nozzle 1 in advance, and a plurality of other plates 17, 18, and 19. Ink filled in the pressure chamber 8 is pressurized by the pressure generating mechanism 13, so the ink droplets 6 are discharged from the nozzle 1.

When the ink droplets 6 are discharged, small satellite droplets sometimes reattach around the nozzle 1. Also, ink overflowing from the nozzle 1 due to an overshoot phenomenon in which ink rises from the nozzle 1 stays around the nozzle 1. Also, a portion around the nozzle 1 is sometimes wetted with ink due to dust and the like that has attached to a portion in the vicinity of the nozzle 1.

FIG. 2 is a sectional view for explaining the inclination of the ink droplets caused by ink wetting. As shown in FIG. 2, due to ink wetting 7, the discharge direction of the ink droplets 6 may be inclined, or the droplet diameter, speed, and the like may vary to largely decrease the printing performance of the ink-jet printing head.

According to the prior art, generally, a film (not shown) repellent against ink is formed on the nozzle surface, thereby suppressing an incidence of ink wetting. Also, wiping (scraping) of the nozzle surface is periodically performed with a rubber wiper or the like to remove ink wetting and dust around the nozzle and to remove attached dust which promotes ink wetting. It is also known to form a step around the nozzle mainly aiming at protecting the nozzle from mechanical friction caused by wiping described above and the like.

The nozzle shape of the prior art is disclosed in, e.g., Japanese Unexamined Patent Publication No. 4-176657. FIG. 3 is a sectional perspective view of a nozzle of this type. A step 3 is formed in a board identical with the nozzle plate 15 having the nozzle 1. The diameter of the step 3 is supposed to be preferably twice to 8 times the diameter of the nozzle 1, and the depth of the step 3 is supposed to be preferably 50 microns or less. Concerning a manufacturing method for the step 3, for example, Japanese Unexamined Patent Publication No. 5-155027 discloses electrical discharge machining, photoetching, pressing using a punch, and laser machining.

The important issue in the nozzle of a practical ink-jet printing head is to prevent ink wetting from remaining around the nozzle as much as possible with a simple manufacturing method and, if ink wetting should occur, to remove it quickly. FIGS. 4A to 4C show a change in ink wetting 7 that takes place as time passes. If the repellent film (not shown) has a good performance, as shown in FIGS. 4A to 4C, the ink wetting 7 (FIG. 4A) is to be drawn to the liquid surface (meniscus) of the nozzle 1 by the function of the surface tension (FIG. 4B), so a normal state with no ink wetting 7 is eventually restored in the vicinity of the nozzle 1 (FIG. 4C).

With the nozzle 1 of the prior art, it takes time until ink 2 is drawn into the nozzle 1. When the ink wetting 7 and dust described above are to be removed by wiping, the ink wetting 7 may be dragged to sometimes cause another ink wetting 7. As a result, the discharge direction, droplet diameter, speed, and the like of the ink droplets 6 vary. Particularly, when the ink droplets 6 are discharged with a high frequency, before the ink wetting 7 in the vicinity of the nozzle 1 disappears, the next ink droplet 6 is discharged, thereby degrading the printing performance.

In order to solve the above problems, as shown in FIG. 5, an annular projection 4 for surrounding the nozzle 1 may be formed around the opening edge of the nozzle 1 that discharges ink. Then, even when ink wetting occurs around the nozzle 1, it is divided by the annular projection 4, and ink wetting inside the annular projection 4 is drawn into the nozzle 1 by the surface tension of the ink. Hence, a normal state with no ink wetting is restored in the vicinity of the nozzle within a short period of time. This structure is disclosed in, e.g., Japanese Unexamined Patent Publication No. 61-57345.

When the opening surface of the nozzle 1 is to be wiped, mechanical friction between the nozzle 1 and the wiper is suppressed by the presence of the annular projection 4. Also, ink wetting and dust for promoting it which are outside the annular projection 4 are blocked out so they will not be dragged toward the inside of the annular projection 4 by wiping.

Alternatively, as shown in FIG. 6, a plurality of annular projections 4 may be formed almost concentrically to surround a nozzle 1. Then, ink wetting around the nozzle 1 is dragged into the nozzle 1 within a short period of time, and the ink wetting and dust are blocked out so they will not move to inside the annular projections 4 by wiping. In addition, since the plurality of annular projections 4 are formed, wear of the annular projections 4 due to mechanical friction such as wiping can be reduced.

Alternatively, as shown in FIG. 7, a planar step 3 may be formed to surround a nozzle 1 such that its bottom surface coincides with the opening surface of the nozzle 1. An annular projection 4 may be formed inside the step 3 to have a height equal to the height of the step 3 or less. Then, any adverse influence of ink wetting can be prevented by the effect of the annular projection 4. Since the step 3 is formed outside the annular projection 4, the annular projection 4 can be protected from mechanical friction accompanying wiping and the like. During wiping, ink wetting and dust enter a portion between the step 3 and annular projection 4, so they are prevented from being dragged into a portion inside the annular projection 4.

In this structure with the annular projection 4, however, when ink wetting 7 occurs, it moves over the annular projection 4, as shown in FIG. 8A. When the normal state is to be restored, the ink wetting 7 undesirably remains outside the annular projection 4, as shown in FIG. 8B. The same phenomenon occurs in a case shown in FIGS. 9A and 9B in which an annular projection 4 is formed inside a step 3. When a head nozzle 1 with the shape shown in FIGS. 9A and 9B is wiped (see FIGS. 10A and 10B), ink wetting 7 sometimes remains inside the annular projection 4 or step 3, as shown in FIG. 10B. For example, when the ink wetting 7 remaining in this manner absorbs fine particles of dust and the like drifting in air, it becomes sticky or solidifies so it is difficult to remove. When the sticky or solidified dust piles up, it can adversely affect printing.

### SUMMARY OF THE INVENTION

The present invention has been made in consideration of the above situation in the prior art, and has as its object to provide a nozzle plate structure in which problems concerning ink wetting described above are solved to prevent a decrease in printing performance of an ink-jet printing head. With the prior art, the nozzle according to the present invention cannot be easily manufactured. It is, therefore, another object of the present invention to provide a method of manufacturing a nozzle according to the present invention.

In order to achieve the above objects, according to the first main aspect of the present invention, there is provided a nozzle plate structure for an ink-jet printing head, comprising an annular projection formed around an opening edge of a nozzle that discharges ink, characterized in that the annular projection has one or a plurality of notches in a circumference thereof.

When wiping is performed, ink wetting and dust sequentially move in a moving direction of wiping, and some ink wetting is absorbed by the ink in the nozzle. Since ink wetting not absorbed through the nozzle moves to the outside of the annular projection through the notch, ink wetting will not stay in the vicinity of the nozzle. In particular, ink wetting and dust located inside the annular projection can be removed to the outside of the annular projection.

The notches are preferably formed at least at two portions including an entering side and exit side through which a wiper enters and exits when wiping the nozzle. As the positions of the notches coincide with the moving direction of wiping, as wiping progresses, ink wetting and dust can be removed from the inside to the outside of the annular projection through the notches.

Alternatively, a nozzle plate structure for an ink-jet printing head according to the present invention is characterized in that the planar shape of the annular projection is an elliptic stream-line body a major-axis direction of which coincides with an entering side and exit side through which a wiper enters and exits when wiping the nozzle. Thus, as wiping progresses, ink wetting and dust in the vicinity of the nozzle move. Even if ink wetting and dust should remain inside the annular projection, they remain most probably only at two ends in the major-axis direction where they adversely affect the nozzle least, and ink wetting and the like do not remain in the vicinity of the nozzle.

Alternatively, the annular projection is desirably formed close to the nozzle opening such that its inner wall is at a distance 2 to 3 times the diameter of the nozzle opening at its innermost portion. Since the annular projection that divides ink wetting is formed close to the nozzle, a region where ink wetting occurs can be decreased in the vicinity of the nozzle. Ink wetting is drawn into the nozzle by the surface tension of the ink within a short period of time, and then a normal state is restored.

Alternatively, a nozzle plate structure for an ink-jet printing head according to the present invention comprises a step which has a lower surface coinciding with a surface, including the opening edge, of the nozzle that discharges ink, and which surrounds the opening edge of the nozzle. The planar shape of the step is an elliptic stream-line body the major-axis direction of which coincides with the entering side and exit side through which a wiper enters and exits when wiping the nozzle. When ink wetting and dust move by wiping, they remain only at the two ends in the major-axis direction of the step with the elliptic stream-line body where they have no adverse influence on the nozzle. Therefore, an adverse effect on the ink discharge performance can be prevented.

According to the second main aspect of the present invention, there is provided a method of manufacturing a nozzle plate for an ink-jet printing head, characterized in that a thin film is formed on an upper surface of a substrate where a nozzle is to be formed, and thereafter a region other than a step or annular projection is removed by etching in accordance with photolithography, thereby forming the step and/or annular projection. In this manner, when a thin film is formed of a material different from that of the substrate where the nozzle is to be formed, and is then removed by etching, the step and annular projection described above can be formed easily.

As is apparent from the above description, according to the present invention, a notch is formed in the annular projection, or the annular projection is formed elliptically, so ink wetting in the vicinity of the nozzle returns to the nozzle quickly, and a good state wherein no ink wetting or dust remains in the vicinity of the nozzle can be obtained. Thus, variations in performance such as the discharge direction of the ink droplets discharged from the respective nozzles can be reduced, and the ink droplets can be discharged with a high frequency. Also, the nozzle plate structure for an ink-jet printing head according to the present invention can be manufactured easily.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a sectional view showing the schematic arrangement of a conventional ink-jet printing head;

FIG. 2 is a sectional view showing an ink droplet inclined discharge state caused by ink wetting in the prior art;

FIG. 3 is a partially sectional perspective view showing the nozzle plate structure of the prior art;

FIGS. 4A to 4C are sectional views for explaining ink wetting and a change in ink wetting state, which takes place as time passes, in the prior art;

FIG. 5 is a partially sectional perspective view showing an example of the annular projection of the prior art;

FIG. 6 is a partially sectional perspective view showing another example of the annular projection of the prior art;

FIG. 7 is a partially sectional perspective view showing a combination of a step and annular projection of the prior art;

FIGS. 8A and 8B are sectional views showing an ink wetting preventive effect achieved by the annular projection of the prior art;

FIGS. 9A and 9B are sectional views showing an ink wetting preventive effect achieved by the combination of the step and annular projection in the prior art;

FIG. 10A and 10B are partially enlarged perspective views showing problems in ink wetting prevention of the prior art;

FIGS. 11A and 11B are respectively a partially sectional perspective view and partially enlarged perspective view showing a nozzle plate structure according to the first embodiment of the present invention;

FIGS. 12A and 12B are partially enlarged perspective views showing an ink wetting preventive effect according to the first embodiment of the present invention;

FIG. 13 is a partially enlarged perspective view showing a nozzle plate structure according to the second embodiment of the present invention;

FIGS. 14A and 14B are respectively a partially sectional perspective view and partially enlarged perspective view showing a nozzle plate structure according to the third embodiment of the present invention;

FIGS. 15A and 15B are partially enlarged perspective views showing an ink wetting preventive effect according to the third embodiment of the present invention; and

FIGS. 16A to 16E are sectional views showing the steps in a method of manufacturing a nozzle plate according to the fourth embodiment of the present invention.

### DETAILED DESCRIPTION OF PREFERRED EMBODIMENTS

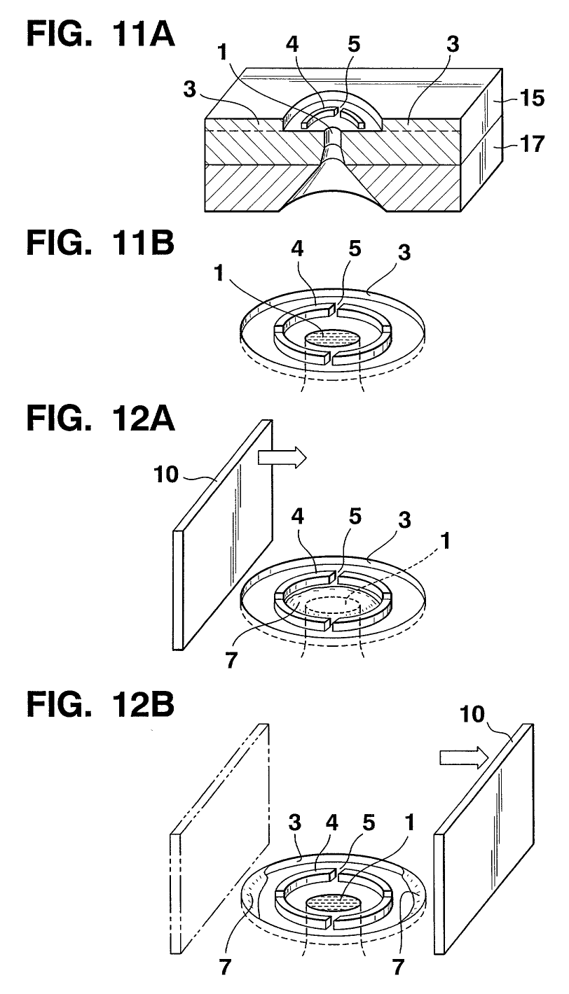

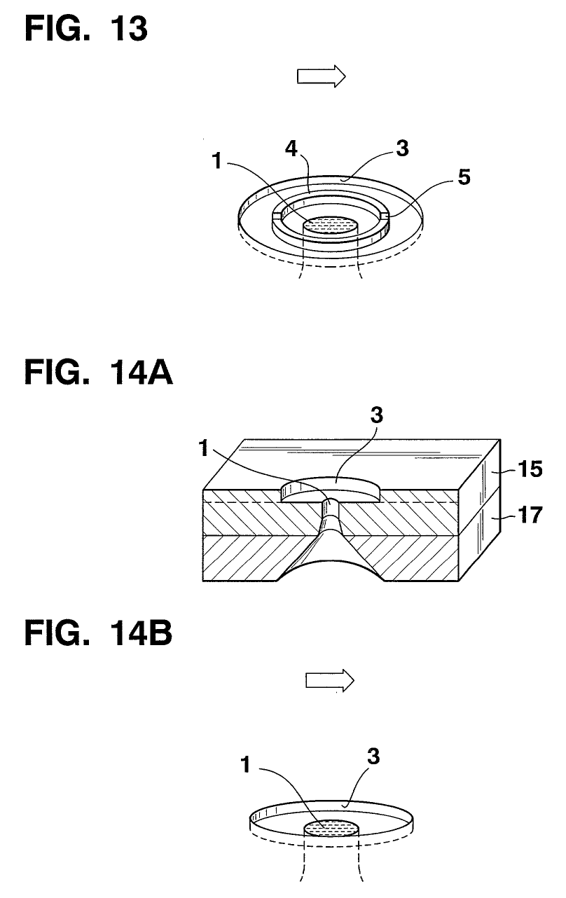

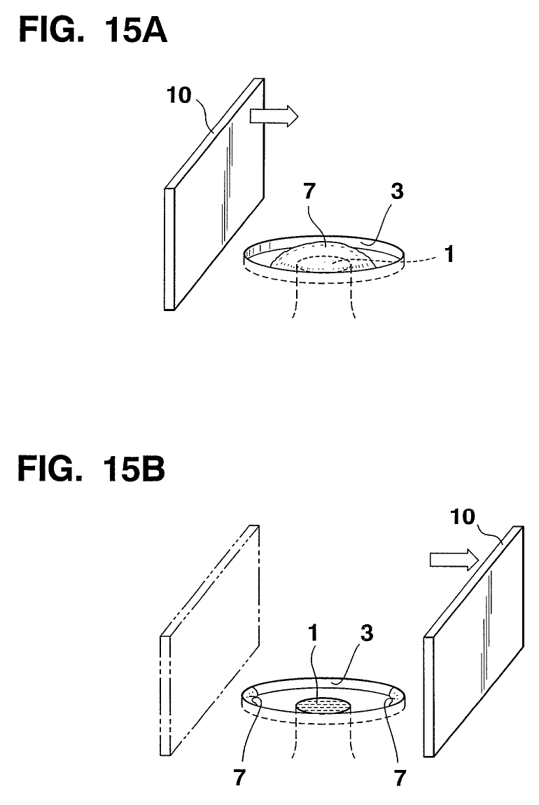

The schematic arrangements of nozzle plate structures for ink-jet printing heads according to several preferred embodiments of the present invention will be described with reference to accompanying FIGS. 11A to 15B. FIGS. 11A and 11B are respectively a sectional perspective view and enlarged perspective view showing notches according to the first embodiment of the present invention. FIGS. 12A and 12B are enlarged perspective views showing an ink wetting preventive effect according to the first embodiment of the present invention. FIG. 13 is an enlarged perspective view showing the second embodiment of the present invention. FIGS. 14A and 14B are respectively a sectional perspective view and enlarged perspective view showing the third embodiment of the present invention. FIGS. 15A and 15B are enlarged perspective views showing an ink wetting preventive effect according to the third embodiment of the present invention.

The present invention relates to a nozzle plate structure for an ink-jet printing head. The characteristic feature of the present invention resides in that, as shown in FIGS. 11A and 11B, an annular projection 4 for surrounding a nozzle 1 is formed around the opening edge of the nozzle 1 that discharges ink, and that one or a plurality of notches 5 are formed in the annular projection 4.

The notches 5 are formed at least at two portions including the entering side and exit side through which a wiper enters and exits when wiping the nozzle 1.

A planar step 3 is formed to surround the nozzle 1 such that its bottom surface coincides with the surface of the nozzle 1. The annular projection 4 is formed inside the step 3 to have a height equal to that of the step 3 or less.

Alternatively, as shown in FIG. 13, a nozzle plate structure for an ink-jet printing head according to the present invention is characterized in that an annular projection 4 for surrounding a nozzle 1 is formed around the opening edge of the nozzle 1 that discharges the ink, and that the planar shape of the annular projection 4 is an elliptic stream-line body the major axis direction of which coincides with the entering side and exit side through which a wiper enters and exits when wiping the nozzle 1.

A plurality of annular projections 4 each formed in the above manner may be formed not to come into contact with each other, as shown in FIG. 6. In this case, of the annular projections 4, one which is on the innermost side is close to the nozzle 1 such that its inner wall is at a distance 2 to 3 times the opening diameter of the nozzle 1.

Alternatively, as shown in FIGS. 14A and 14B, a nozzle plate structure for an ink-jet printing head according to the present invention is characterized in that its bottom surface coincides with the surface of a nozzle 1 which discharges ink, and that a step 3 for surrounding the nozzle 1 is formed such that its planar shape is an elliptic stream-line body the major-axis direction of which coincides with the entering side and exit side through which a wiper enters and exits when wiping the nozzle 1.

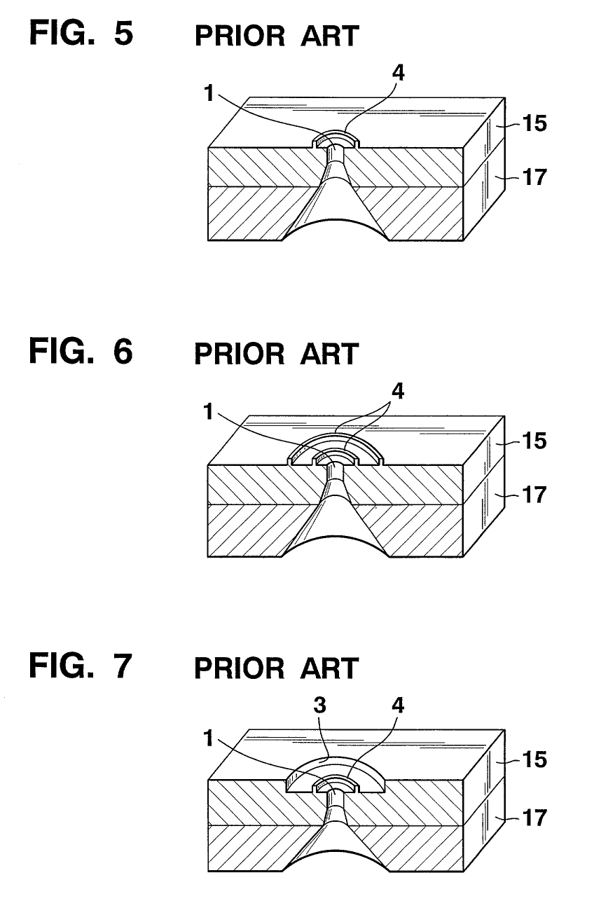

Prior to description of the embodiments, the practical effects of the annular projection and step will be described with reference to FIGS. 5 to 9B. As shown in FIG. 5, one annular projection 4 concentric with and surrounding the nozzle 1 is formed around the opening edge of the nozzle 1. The nozzle 1 has an opening diameter of 28 microns. The annular projection 4 has a diameter of 70 microns, a planar width of 20 microns in the radial direction, and a height of 5 microns from the surface of the nozzle 1.

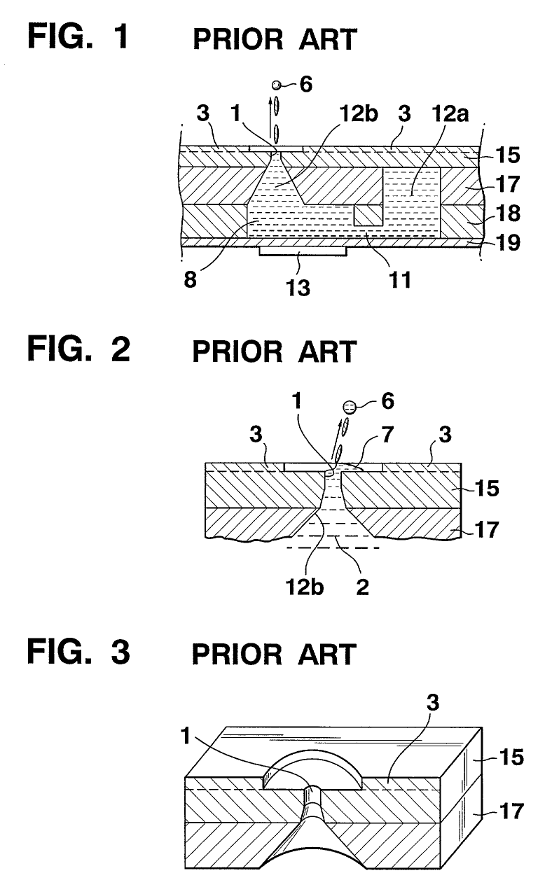

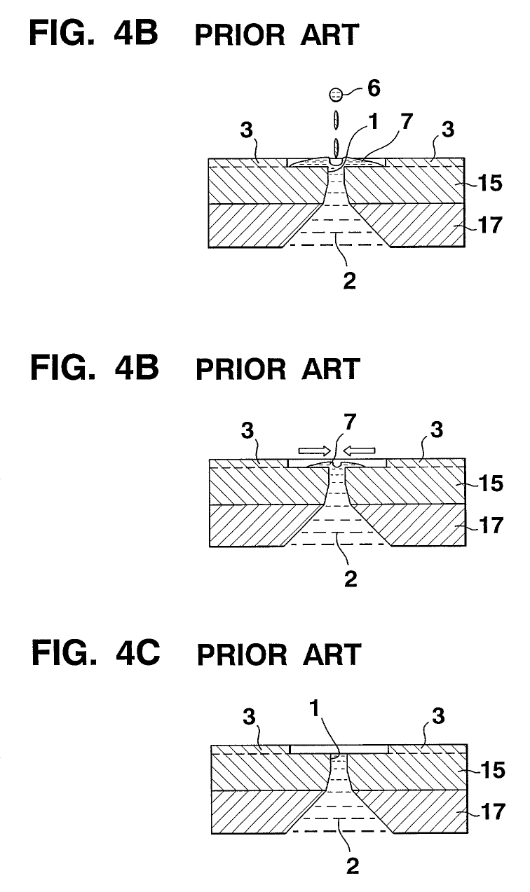

The practical effect obtained with the annular projection 4 will be described. First, using a nozzle plate 15 shown in FIG. 5, an ink-jet printing head with the arrangement shown in FIG. 1 was assembled. An experiment of discharging ink droplets 6 from the nozzle 1, and its evaluation were performed. The behavior of the ink droplets 6 and ink wetting 7 around the nozzle 1 was examined by stroboscopic radiation and observation using a high-speed camera.

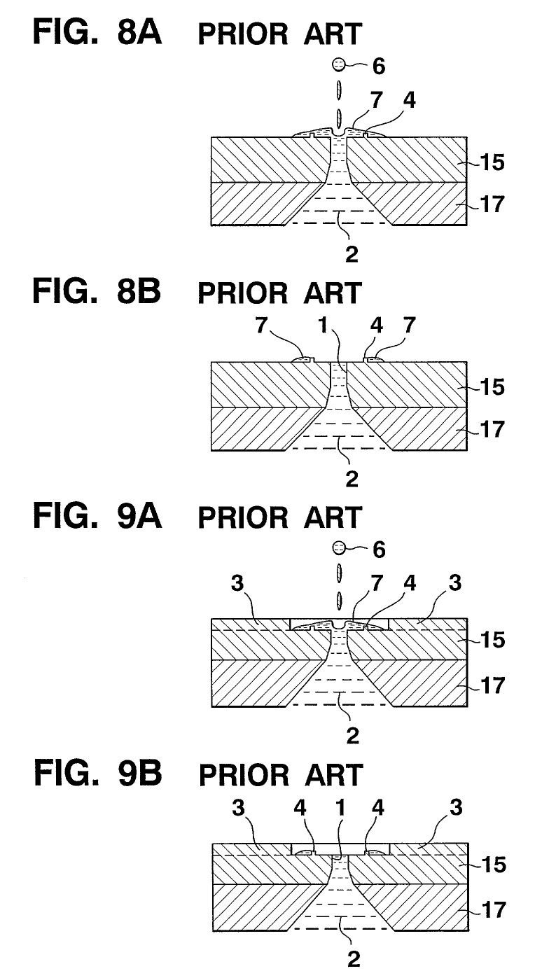

FIG. 8A shows, in a case wherein ink droplets 6 are discharged with such a condition that ink wetting 7 tends to occur easily, the state of ink wetting 7 in the vicinity of the nozzle 1 immediately after ink droplets 6 are discharged, and FIG. 8B shows a change in ink wetting 7 that takes place as time passes. As shown in FIGS. 8A and 8B, although the ink wetting 7 occurring around the nozzle 1 temporarily spread to outside the annular projection 4, it was divided by the annular projection 4 several microseconds after that, and the ink wetting 7 inside the annular projection 4 was drawn into the nozzle 1 by the surface tension of the ink 2.

Therefore, in about 25 microseconds since immediately after discharge, a normal state with no ink wetting in the vicinity of the nozzle was restored. For the purpose of comparison, by using a nozzle plate 15 with no annular projection 4, the difference in ink wetting 7 was examined. Consequently, under the same condition, the time required until a normal state with no ink wetting was restored was about 50 microseconds since immediately after discharge.

By using an ink-jet printing head manufactured with the nozzle plate 15 shown in FIG. 5, discharge of ink droplets 6 and the behavior of ink wetting 7 and dust when the nozzle 1 was wiped were examined. The portion around the annular projection 4 was observed particularly closely. The ink wetting 7 and dust for promoting it, which are outside the annular projection 4, were dragged to the annular projection 4 by wiping. However, because of the blocking effect of the annular projection 4, the ink wetting 7 and dust did not enter through the annular projection 4.

In the above example, since the annular projection 4 was formed, the ink wetting 7 in the vicinity of the nozzle 1 could be returned to the nozzle 1 with a short period of time, and when wiping was performed, the ink wetting 7 and dust could be prevented from entering through the annular projection 4. Because of the presence of the annular projection 4, friction between the nozzle 1 and the wiper was reduced.

As shown in FIG. 6, the two concentric annular projections 4 were formed around the nozzle 1. The inner annular projection 4 had a diameter of 70 microns, and the outer annular projection 4 had a diameter of 90 microns. Both the annular projections 4 had equal planar widths of 20 microns, and equal heights of 5 microns from the surface of the nozzle 1. An ink-jet printing head was assembled by using this nozzle 1, and the behavior of ink wetting 7 around the nozzle 1 was observed.

As a result of an experiment and its evaluation, the same effect was obtained. That is, the ink wetting was divided by the annular projections 4, and the ink wetting inside the annular projections 4 was drawn into the nozzle 1 by the surface tension of the ink.

Similarly, a normal state was restored in about 25 microseconds since immediately after discharge, and when wiping of the nozzle 1 was performed, the ink wetting and dust did not enter through the annular projections 4 because of the blocking effect of the annular projections 4. Since the plurality of annular projections 4 were formed, durability against mechanical friction such as wiping could be improved.

More specifically, when one annular projection 4 is formed, it strongly comes into contact with the wiper. In contrast to this, when a plurality of annular projections 4 were formed, as shown in FIG. 6, the outer annular projection 4 comes into contact with the wiper the strongest, and the inner annular projection 4 comes into contact with the wiper lightly when compared to the outer one. As a result, friction with the wiper and wear accompanying it were reduced, so the durability of the annular projections 4 could be improved. This effect is enhanced when the inner annular projection 4 is set lower than the outer one.

A case will be described wherein an annular step 3 is formed around an annular projection 4 such that its bottom surface coincides with the surface of the nozzle 1, as shown in FIG. 7. In this case, the annular projection 4 had a diameter of 70 microns, a planar width of 20 microns, and a height of 50 microns, and was formed concentrically with the nozzle 1. The step 3 was formed outside the annular projection 4 to have a diameter of 150 microns and a height of 5 microns from the surface of the nozzle 1. Using the nozzle plate shown in FIG. 7, an ink-jet printing head was assembled, and ink droplets 6 and ink wetting 7 around the nozzle 1 were examined.

FIG. 9A shows the ink wetting 7 in the vicinity of the nozzle 1 immediately after the ink droplets 6 are discharged, and FIG. 9B shows a state wherein the ink wetting 7 is drawn back to the nozzle 1 as time passes.

As a result of an experiment and its evaluation, although the ink wetting 7 spread once to outside the annular projection 4, it was divided by the annular projection 4 several microseconds after that. Thus, a normal state with no ink wetting 7 in the vicinity of the nozzle 1 was restored in about 25 microseconds since immediately after discharge. The effect of the annular projection 4 to prevent the ink wetting 7 was confirmed. Since the step 3 was formed, the annular projection 4 located inside the step 3 comes into contact with the wiper lightly. Therefore, wear of the annular projection 4 was reduced to improve the durability.

In the wiping evaluation of the nozzle 1, most of the ink wetting 7 and dust outside the annular projection 4, which had been dragged by the wiper, entered the portion between the step 3 and annular projection 4. Accordingly, the ink wetting 7 and dust could be prevented from remaining inside the annular projection 4, particularly in the vicinity of the nozzle 1.

In the above example, one annular projection 4 is formed inside the step 3. To further improve the durability of the annular projection 4 against wear during wiping and the effect of dividing the ink wetting 7, a plurality of annular projections 4 may be formed. Also, if the annular projection 4 is formed lower than the step 3, the durability is further improved.

### First Embodiment

The first embodiment of the present invention will be described. So far the practical effects of the annular projection 4 and step 3 have been described. In the first embodiment of the present invention, a plurality of notches 5 are formed in the annular projection 4, as shown in FIGS. 11A and 11B. In this embodiment, one annular projection 4, and the step 3 outside it were formed concentrically with the nozzle 1, and a total of 4 notches 5 were formed in the entering side and exit side through which a wiper 10 enters and exits when performing wiping, and directions different from them by about 90 degrees.

The annular projection 4 had a diameter of 70 microns, a planar width of 20 microns, and a height of 5 microns. The step 3 had a diameter of 150 microns and a height of 5 microns from the surface of the nozzle 1. Each notch 5 had a width of 10 microns in the circumferential direction and was formed to separate the annular projection 4.

An ink-jet printing head was assembled in the same manner as described above, and discharge of the ink droplets 6 and experiment and evaluation of wiping were performed. As a result, the effect of removing ink wetting 7 immediately from the vicinity of the nozzle 1 and the effect of the step 3 to improve the durability of the annular projection 4 could be confirmed.

When the notches 5 are formed in the annular projection 4, any adverse effect of the ink wetting 7 which is caused by wiping can be further reduced. As shown in FIGS. 12A and 12B, as the wiper 10 moves forward, the ink wetting 7 and dust (not shown) outside the step 3 sequentially move together with the wiper 10, and part of the ink wetting 7 is absorbed by the ink in the nozzle 1. The ink wetting 7 which had not been absorbed by the nozzle 1 and the ink wetting 7 and dust present inside the annular projection 4 before wiping mostly moved to the outside of the annular projection 4 through the notches 5, and remained only slightly in the vicinity of the step 3. The effect of this embodiment can be similarly obtained in an arrangement with a plurality of annular projection 4.

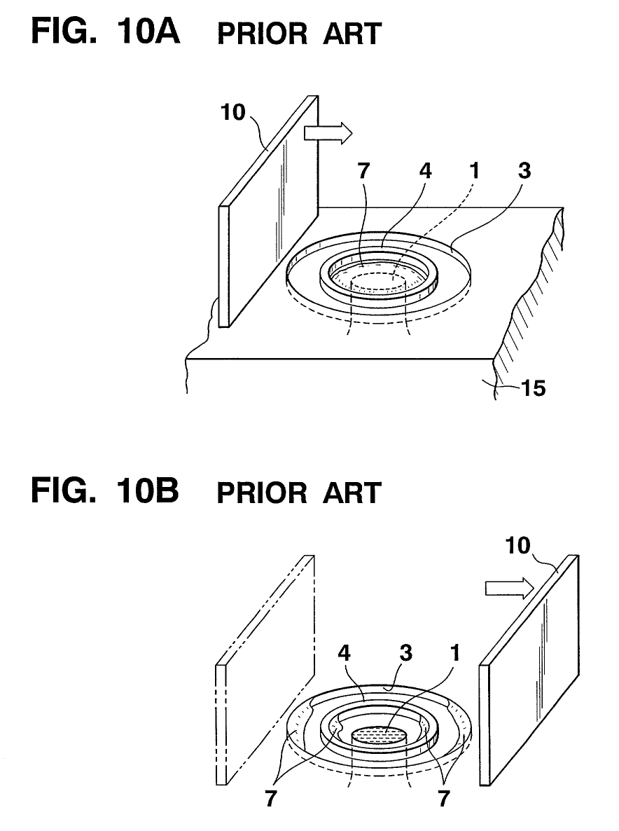

For the purpose of comparison, similar evaluation was performed with an annular projection 4 with no notch 5. As shown in FIGS. 10A and 10B, the ink wetting 7 and dust sometimes remained inside the annular projection 4. In contrast to this, in the first embodiment in which the notches 5 were formed, the probability that the ink wetting 7 and dust remain in the vicinity of the nozzle 1 was further reduced.

### Second Embodiment

The second embodiment of the present invention will be described with reference to FIG. 13. The arrangement of the second embodiment is different from that of the first embodiment in that the planar shape of the annular projection 4 is an elliptic stream-line body. The major axis coincided with the wiping direction with respect to the nozzle 1, and its minor axis was in the direction making 90 degrees with the wiping direction.

The annular projection 4 of this embodiment had a planar width of 20 microns, a height of 5 microns, a major-axis diameter of 100 microns, and a minor-axis diameter of 60 microns. This annular projection 4 was formed one inside the step 3 which had a diameter of 150 microns and a height of 5 microns from the surface of the nozzle 1. Concerning notches 5, they were formed, each with a width of 10 microns in the circumferential direction, to separate the annular projection 4. Two notches 5 were formed one each on the entering side and exit side through which a wiper 10 entered and exited when performing wiping.

In this embodiment as well, in the same manner as in the first embodiment described above, an ink-jet printing head was assembled, and ink wetting 7 around the nozzle 1 was observed. As the ink wetting 7 in the vicinity of the nozzle 1 was divided by the annular projection 4, it was quickly returned to the nozzle 1, and that since the annular projection 4 was formed inside the step 3, the durability against wiping could be improved.

Also, since the notches 5 were formed in the same manner as in the first embodiment, the ink wetting and dust could be removed to the outside of the annular projection 4.

Furthermore, in the second embodiment, the annular projection 4 was formed with an elliptic stream-line body. Thus, even if ink wetting and dust remained inside the annular projection 4 as wiping progressed, they remained mostly only at the two ends in the major-axis direction of the ellipse. Because of the effect of the elliptic shape, the ink wetting and dust inside the annular projection 4 could easily move in the wiping direction, so the effect of removing the ink wetting and dust from the inside to the outside of the annular projection 4 was further improved. Therefore, the possibility that ink wetting and dust remain in the vicinity of the nozzle 1 could be further reduced. The effect of this embodiment can also be similarly obtained with an arrangement in which a plurality of annular projections 4 are formed.

### Third Embodiment

The third embodiment of the present invention will be described with reference to FIGS. 14A to 15B. The third embodiment is different from the first and second embodiments in that the step 3 is formed to have an elliptic stream-line body the major-axis direction of which coincides with the moving direction of a wiper 10, and that no annular projection is formed.

The step 3 of this embodiment was formed to have a height of 5 microns from the surface of the nozzle 1, a major-axis diameter, in the moving direction of the wiper 10, of 100 microns, and a minor-axis diameter of 60 microns. Using the nozzle 1 with this step 3, an ink-jet printing head almost identical to the structure shown in FIG. 1 was assembled, and the effect of the step 3 was examined. Since the minor-axis portion of the step 3 was formed close to the nozzle 1, even if ink wetting 7 occurred, it quickly returned to the nozzle 1.

The other effect of the third embodiment is in that, when the wiper 10 wipes a portion around the nozzle 1, even if the ink wetting 7 and dust remain inside the step 3, they remain only at the two ends in the major-axis direction of the step 3 with the elliptic stream-line body. The two ends of the step 3 were where the ink wetting 7 and dust did not adversely affect the nozzle 1, and that an adverse effect on the ink discharge performance could be prevented. Although no annular projection was formed in this embodiment, an annular projection 4 may be formed inside the step 3 with the elliptic stream-line body.

### Fourth Embodiment

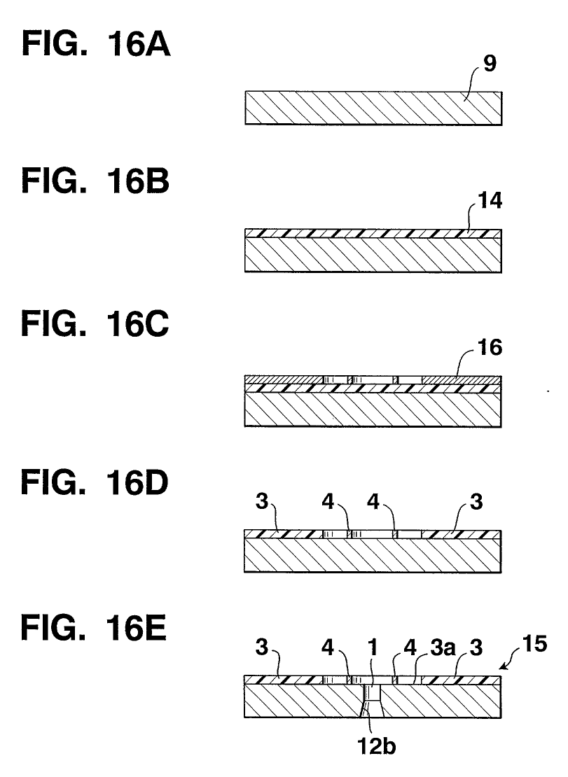

The fourth embodiment of the present invention will be described with reference to FIGS. 16A to 16E. This embodiment exemplifies the manufacture of a nozzle plate. The steps in manufacturing a nozzle plate with one annular projection 4 inside a step 3 will be described with reference to FIGS. 16A to 16E. A nozzle plate with no annular projection 4, a nozzle plate with no step 3 but with only an annular projection 4, a nozzle plate with a plurality of annular projections 4, and a nozzle plate with a notch 5 in its annular projection 4 were manufactured by the same method including the following same manufacturing steps.

First, as shown in FIG. 16A, a thin film 14 is formed on a substrate 9 which is to have a nozzle to thus form a nozzle plate 15 (see FIG. 16B). The substrate 9 was obtained by cutting a silicon single-crystal wafer. The thin film 14 was formed by depositing polysilicon to a thickness of 5 microns by the CVD process. A resist 16 was formed on a predetermined region of the polysilicon thin film 14 formed into the shape of a step and/or an annular projection (see FIG. 16C), and its regions other than the step 3 and annular projection 4 were formed by photolithography. The thin film in the opening was etched by wet wetting. After that, the resist 16 was removed (see FIG. 16D). In this manner, the step 3 and/or annular projection 4 is formed on the upper surface of the silicon substrate 9.

In the fourth embodiment, the step 3 and annular projection 4 were formed in the above steps. After that, an opening portion of the nozzle 1 was formed at substantially the central portion of a lower surface 3a, surrounded by the step 3 and/or annular projection 4, by photolithography and RIE (dry etching). Finally, that portion of the surface 3a which corresponded to the nozzle opening was subjected to silicon single-crystal anisotropic wet etching from the lower surface of the nozzle 1, so that it was etched in a tapered shape to form a nozzle communicating hole 12b (see FIG. 16E), thereby manufacturing the nozzle plate 15 (see FIG. 16E). Through the above photolithography process, the step and annular projection described in the above embodiment could be formed easily.

A film repellent against ink is formed on the surface of the nozzle plate 15. After that, as shown in FIG. 1, this nozzle plate 15, a pool plate 17 with an ink pool 12a and the nozzle communicating hole 12b which extends to the nozzle, a pressure chamber plate 18 with a pressure chamber 8 for applying pressure to the ink and a supply line 11 for connecting the pressure chamber 8 and ink pool 12a, and a seal plate 19 are sequentially stacked and bonded to each other by an adhesive or the like.

In the fourth embodiment, a piezo-actuator is utilized as each pressure generating mechanism 13. The piezo-actuator is bonded to an outer side of the plate 19 which corresponds to the pressure chamber 8. Interconnections were connected to pressure generating mechanisms 13 corresponding to the respective nozzles 1, so separate voltages could be applied to the pressure generating mechanisms 13, thereby manufacturing an ink-jet printing head. When a voltage waveform is applied to each pressure generating mechanism 13 to push the pressure chamber 8 upward from below, the ink filled in the pressure chamber 8 is pressurized, so the ink droplets 6 are discharged from the nozzle 1.

In the fourth embodiment, the thin film was formed of polysilicon by CVD. Alternatively, a thin film may be formed of other materials by plating or spin coating. Although the nozzle plate was manufactured by using a silicon single-crystal substrate, it may be formed from other crystal substrates or metal plates.

The nozzle was formed after the step and annular projection were formed. Alternatively, a step and annular projection may be formed in a substrate formed with a nozzle in advance. In the fourth embodiment, the nozzle was formed by photolithography. Alternatively, to form a nozzle, a method of forming a small hole in a metal plate by pressing, electroforming utilizing nickel or the like, or other means may be used.

What is claimed is:

1. A nozzle plate structure for an ink-jet printing head, comprising an annular projection formed around an opening edge of a nozzle that discharges ink, wherein said annular projection has one or a plurality of notches in a circumference thereof.

2. A structure according to claim 1, wherein said notches are formed at least at two portions including an entering side and exit side through which a wiper enters and exits when wiping a portion around said opening edge of said nozzle.

3. A structure according to claim 1, wherein said structure further comprises a step which surrounds said annular portion and has said opening edge of said nozzle formed in a lower surface thereof, and said annular projection has a height not more than that of said step.

4. A structure according to claim 1, wherein said annular projection comprises a plurality of annular projections formed coaxially with a center of an opening of said nozzle, so as not to come into contact with each other.

5. A structure according to claim 1, wherein said annular projection is formed close to said opening edge of said nozzle such that an inner wall of said annular projection is at a distance 2 to 3 times a diameter of said nozzle opening.

6. A structure according to claim 4, wherein of said plurality of annular projections, an annular projection formed closest to said opening edge of said nozzle has an inner wall close to said opening edge of said nozzle at a distance 2 to 3 times a diameter of said nozzle opening.

7. A nozzle plate structure for an ink-jet printing head, comprising an annular projection formed around an opening edge of a nozzle that discharges ink, wherein said annular projection has a planar shape with an elliptic stream-line body a major-axis direction of which coincides with a direction along an entering side and exit side through which a wiper enters and exits when wiping said nozzle, and has one or a plurality of notches in a circumference thereof.

8. A structure according to claim 7, wherein said notches are formed at least at two portions including said entering side and exit side through which said wiper enters and exits when wiping a portion around said opening edge of said nozzle.

9. A structure according to claim 7, wherein said structure further comprises a step which surrounds said annular portion and has said opening edge of said nozzle formed in a lower surface thereof, and said annular projection has a height not more than that of said step.

10. A structure according to claim 7, wherein said annular projection comprises a plurality of annular projections formed coaxially with a center of an opening of said nozzle, so as not to come into contact with each other.

11. A structure according to claim 7, wherein said annular projection with said elliptic stream-line body is formed close to said opening edge of said nozzle such that an inner wall, on a minor-axis side, of said annular projection is at a distance 2 to 3 times a diameter of said nozzle opening.

12. A structure according to claim 10, wherein of said plurality of annular projections with elliptic stream-line bodies, an annular projection with an elliptic stream-line body and formed closest to said opening edge of said nozzle has an inner wall, on a minor-axis side, which is formed close to said opening edge of said nozzle at a distance 2 to 3 times a diameter of said nozzle opening.

13. A nozzle plate structure for an ink-jet printing head, comprising a step formed around an opening edge of a nozzle that discharges ink, wherein said step has a planar shape with an elliptic stream-line body a major-axis direction of which coincides with a direction along an entering side and exit side through which a wiper enters and exits when wiping said nozzle.

14. A structure according to claim 13, wherein said step with said elliptic stream-line body has an inner wall, on a minor-axis side, which is formed close to said opening edge of said nozzle at a distance 2 to 3 times a diameter of said nozzle opening.

15. A method of manufacturing a nozzle plate for an ink-jet printing head, comprising the steps of forming a polysilicon thin film on an upper surface of a silicon substrate by a CVD process, forming a resist film on a predetermined region of said polysilicon thin film formed into a step and/or an annular projection, forming a step and/or an annular projection on said upper surface of said substrate by removing, by etching, said polysilicon thin film in an opening where said resist film is not formed, forming a nozzle opening, by photolithography and RIE, at a substantially center of a low surface surrounded by said step and/or said annular projection, and forming a tapered nozzle communication hole by subjecting, to anisotropic wet etching, that portion of a lower surface of said silicon substrate which corresponds to said nozzle opening.
